(19) United States
(12) Patent Application Publication
(10) Pub. No.: US 2005/0095943 A1
(43) Pub. Date: May 5, 2005

(54) Cross machine direction extensible nonwoven webs

(75) Inventors: Rebecca Willey Griffin, Woodstock, GA (US); James Anthony Riggs, East Point, GA (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/697,465

(22) Filed: Oct. 30, 2003

(51) Int. Cl. B29D 24/00; D04H 1/06; B29D 29/00; D04H 5/06; B29C 43/02; B29D 29/08; B29C 51/00; B29C 49/00; B29D 29/06; D04H 13/00; D04H 1/54; D04H 3/14; D04H 3/00; D04H 1/00; D04H 5/00; D01D 5/22

(52) U.S. Cl. 442/352; 442/353; 442/359; 442/409; 264/546; 264/168

(57) ABSTRACT

Disclosed herein are bonded cross machine direction extensible nonwoven web materials and a process for making, and laminates of the cross machine direction extensible nonwoven web materials. The extensible nonwoven webs are of substantially uniform basis weight and comprise continuous thermoplastic fibers having an average diameter greater than about 10 microns and a plurality of thermal bond points in a pattern and the nonwoven web. In certain embodiments, the force required to extend the bonded nonwoven web 30 percent in the cross machine direction is less than about 60 percent of the cross machine direction peak tensile force of the bonded nonwoven web. In other embodiments, the force required to extend the bonded nonwoven web 30 percent in the cross machine direction is less than about 30 percent of the force required to extend the web to 30 percent in the machine direction.

### FIELD

This invention relates to extensible nonwoven web materials and a method for making, and to laminates of extensible nonwoven web materials.

### BACKGROUND OF THE INVENTION

Many of the medical care garments and products, protective wear garments, mortuary and veterinary products, and personal care products in use today are partially or wholly constructed of nonwoven materials. Examples of such products include, but are not limited to, medical and health care products such as surgical drapes, gowns and bandages, protective workwear garments such as coveralls and lab coats, and infant, child and adult personal care absorbent articles such as diapers, training pants, disposable swimwear, incontinence garments and pads, sanitary napkins, wipes and the like. For these applications nonwoven fibrous webs provide functional, tactile, comfort and aesthetic properties which can approach or even exceed those of traditional woven or knitted cloth materials. Nonwoven materials are also widely utilized as filtration media for both liquid and gas or air filtration applications since they can be formed into a lofty filter mesh of fibers having a low average pore size suitable for trapping particulate matter while still having a low pressure drop across the mesh.

However, ongoing research continues to improve the cloth-like aesthetics of such nonwoven web materials. Nonwoven webs are typically bonded by heat and pressure or by adhesives at the inter-fiber crossover points rather than having fibers woven or knitted. Because of bonding at fiber crossings, the fibers of nonwovens are generally not as freely allowed to slip past one another as are fibers in a knit or woven material, and therefore one particular disadvantage of traditional nonwoven materials is that they tend to have less extensibility, that is, the ability to “give” or extend upon application of an applied force. When a nonwoven material is incorporated into an article to be worn on a user's body, extensibility is an important attribute allowing for body conformance and improved cloth-like feeling of the article upon the user's body.

One known solution to this problem has been to incorporate elastomeric or elastic materials into the article. Unfortunately, incorporation of such materials generally results in increased costs due to more expensive material components. Furthermore, elastic materials often have unpleasant tactile aesthetic properties, such as feeling rubbery or tacky to the touch, making them unpleasant and uncomfortable against the wearer's skin.

Cross machine direction extensible laminate materials of elastic and non-elastic materials have been made by bonding a non-elastic material or web to an elastic material in a manner that allows the entire laminate or composite material to stretch or elongate so it can be used in disposable products. In one such laminate material, disclosed, for example, by Vander Wielen et al. U.S. Pat. No. 4,720,415, issued Jan. 19, 1988, a non-elastic web material is bonded to an elastic material while the elastic material is held stretched so that when the elastic material is relaxed, the non-elastic web material gathers between the bond locations, and the resulting stretch-bonded laminate material is stretchable to the extent that the non-elastic web material gathered between the bond locations allows the elastic material to elongate. In another such cross machine direction extensible laminate material, disclosed for example by U.S. Pat. Nos. 5,336,545, 5,226,992, 4,981,747 and 4,965,122 to Morman, a non-elastic web material is necked (that is, is elongated in one direction, usually the machine direction, causing rugosities to form across the web) and is joined to an elastic material while the non-elastic material is in the necked or elongated condition. The non-elastic material is then able to be extended in the direction perpendicular to the direction of necking, allowing for extensibility of the laminate. Additionally well known in the art are methods for modifying the extensibility of the nonwoven web by incrementally stretching, such as may be performed by use of an interdigitating roller apparatus. Another method for forming cross machine direction extensible nonwoven webs is disclosed in U.S. Pat. No. 6,319,455 to Kauschke et al., wherein nonwoven webs are produced having alternating heavy and light stripes or high density and low density strips across the material which run in the machine direction. According to the disclosure of U.S. Pat. No. 6,319,455, these low density strips help provide cross machine direction elongation ability.

Notwithstanding the foregoing, there is a continuing need for cross machine direction extensible nonwoven materials. Necking, stretch-bonding and groove rolling produce suitably cross machine direction extensible materials but require one or more additional processing steps after the nonwoven web has been formed, and also require additional processing equipment. A nonwoven web having the alternating light and heavy stripes will consequently have a visually non-uniform or streaky appearance, rather than a substantially uniform visual appearance, that is, a more uniform and clothlike visual appearance.

### SUMMARY OF THE INVENTION

The present invention provides a method of making as formed cross direction extensible nonwoven web including the steps of extruding continuous thermoplastic fibers having an average diameter greater than about 10 microns, quenching the fibers, melt-attenuating the fibers, collecting the fibers on a moving foraminous forming surface to form an unbonded nonwoven web, and pattern bonding the nonwoven web by the application of heat and pressure, where the bonded nonwoven web has substantially uniform basis weight, and also where the tensile force required to extend the bonded nonwoven web 30 percent in the cross machine direction is less than about 60 percent of the cross machine direction peak tensile force of the bonded nonwoven web. Desirably, the force required to extend the bonded nonwoven web 30 percent in the cross machine direction may be less than about 50 percent of the cross machine direction peak tensile force, and more desirably the force required to extend the bonded nonwoven web 30 percent in the cross machine direction may be less than about 40 percent of the cross machine direction peak tensile force. The bonded nonwoven web may have a MD:CD tensile strength ratio of at least about 3:1. The continuous thermoplastic fibers may be extruded in a crimpable cross sectional configuration such as a side-by-side or eccentric sheath-core configuration and the method may further include the step of applying heat to the fibers to activate crimp. The step of applying heat may be performed before or after the step of collecting the fibers on the forming surface. The method may further include the step of laminating the nonwoven web to at least one additional layer, and the additional layer or layers may be such as breathable films, elastic films, foams, and nonwoven webs.

The invention further provides a cross machine direction extensible nonwoven web comprising continuous thermoplastic fibers and a plurality of thermal bond points in a pattern, the continuous thermoplastic fibers having an average diameter greater than about 10 microns and the nonwoven web having substantially uniform basis weight, where the force required to extend the bonded nonwoven web 30 percent in the cross machine direction is less than about 60 percent of the cross machine direction peak tensile force of the bonded nonwoven web. Desirably, the force required to extend the bonded nonwoven web 30 percent in the cross machine direction may be less than about 50 percent of the cross machine direction peak tensile force, and more desirably the force required to extend the bonded nonwoven web 30 percent in the cross machine direction may be less than about 40 percent of the cross machine direction peak tensile force.

In another embodiment, a cross machine direction extensible nonwoven web is provided having continuous thermoplastic fibers and a plurality of thermal bond points in a pattern, the continuous thermoplastic fibers having an average diameter greater than about 10 microns and the nonwoven web having substantially uniform basis weight, where the force required to extend the bonded nonwoven web 30 percent in the cross machine direction is less than about 30 percent of the force required to extend the web to 30 percent in the machine direction. Desirably, the force required to extend the bonded nonwoven web 30 percent in the cross machine direction is less than about 25 percent of the force required to extend the web to 30 percent in the machine direction, and even more desirably the force required to extend the bonded nonwoven web 30 percent in the cross machine direction may be less than about 20 percent of the force required to extend the web to 30 percent in the machine direction.

In embodiments of the above, the fibers may desirably be crimped multicomponent fibers, and in still other embodiments are provided laminates of the extensible nonwoven web with one or more additional layers such as breathable films, elastic films, foams, and nonwoven webs.

### BRIEF DESCRIPTION OF THE DRAWINGS

FIG. 1 is a schematic illustration of a process for forming the cross machine direction extensible nonwoven web material of the present invention.

FIG. 2 is an illustration of a laminate material comprising the cross machine direction extensible nonwoven web material.

FIG. 3-FIG. 7 are bar graphs illustrating the extensibility properties of the cross machine direction extensible nonwoven webs of the invention.

### DEFINITIONS

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of”.

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and random symmetries. As used herein the term “thermoplastic” or “thermoplastic polymer” refers to polymers which will soften and flow or melt when heat and/or pressure are applied, the changes being reversible.

As used herein the term “fibers” refers to both staple length fibers and substantially continuous filaments, unless otherwise indicated. As used herein the term “substantially continuous” with respect to a filament or fiber means a filament or fiber having a length much greater than its diameter, for example having a length to diameter ratio in excess of about 15,000 to 1, and desirably in excess of 50,000 to 1.

As used herein the term “monocomponent” fiber refers to a fiber formed from one or more extruders using only one polymer. This is not meant to exclude fibers formed from one polymer to which small amounts of additives have been added for color, anti-static properties, lubrication, hydrophilicity, etc.

As used herein the term “multicomponent fibers” refers to fibers which have been formed from at least two component polymers, or the same polymer with different properties or additives, extruded from separate extruders but spun together to form one fiber. Multicomponent fibers are also sometimes referred to as conjugate fibers or bicomponent fibers, although more than two components may be used. The polymers are arranged in substantially constantly positioned distinct zones across the cross-section of the multicomponent fibers and extend continuously along the length of the multicomponent fibers. The configuration of such a multicomponent fiber may be, for example, a concentric or eccentric sheath/core arrangement wherein one polymer is surrounded by another, or may be a side by side arrangement, an “islands-in-the-sea” arrangement, or arranged as pie-wedge shapes or as stripes on a round, oval or rectangular cross-section fiber, or other. Multicomponent fibers are taught in U.S. Pat.

U.S. Pat. No. 5,108,820 to Kaneko et al., U.S. Pat. No. 5,336,552 to Strack et al., and U.S. Pat. No. 5,382,400 to Pike et al. For two component fibers, the polymers may be present in ratios of 75/25, 50/50, 25/75 or any other desired ratios. In addition, any given component of a multicomponent fiber may desirably comprise two or more polymers as a multiconstituent blend component.

As used herein the term “biconstituent fiber” or “multiconstituent fiber” refers to a fiber formed from at least two polymers, or the same polymer with different properties or additives, extruded from the same extruder as a blend. Multiconstituent fibers do not have the polymer components arranged in substantially constantly positioned distinct zones across the cross-section of the multicomponent fibers; the polymer components may form fibrils or protofibrils which start and end at random.

As used herein, the term “crimp” means a three-dimensional curl or crimp such as, for example, a helical crimp and does not include random two-dimensional waves or undulations in a fiber.

As used herein the term “nonwoven web” or “nonwoven fabric” means a web having a structure of individual fibers or filaments which are interlaid, but not in an identifiable manner as in a knitted or woven fabric. Nonwoven fabrics or webs have been formed from many processes such as for example, meltblowing processes, spunbonding processes, airlaying processes, and carded web processes. The basis weight of nonwoven fabrics is usually expressed in grams per square meter (gsm) or ounces of material per square yard (osy) and the fiber diameters useful are usually expressed in microns. (Note that to convert from osy to gsm, multiply osy by 33.91).

The term “spunbond” or “spunbond fiber nonwoven fabric” refers to a nonwoven fiber fabric of small diameter fibers that are formed by extruding molten thermoplastic polymer as fibers from a plurality of capillaries of a spinneret. The extruded fibers are cooled while being drawn by an eductive or other well known drawing mechanism. The drawn fibers are deposited or laid onto a forming surface in a generally random, isotropic manner to form a loosely entangled fiber web, and then the laid fiber web is subjected to a bonding process to impart physical integrity and dimensional stability. The production of spunbond fabrics is disclosed, for example, in U.S. Pat. No. 4,340,563 to Appel et al., U.S. Pat. No. 3,802,817 to Matsuki et al. and U.S. Pat. No. 3,692,618 to Dorschner et al. Typically, spunbond fibers have a weight-per-unit-length in excess of 2 denier and up to about 6 denier or higher, although both finer and heavier spunbond fibers can be produced. In terms of fiber diameter, spunbond fibers often have an average diameter of larger than 7 microns, and more particularly between about 10 and about 25 microns, and up to about 30 microns or more.

As used herein the term “meltblown fibers” means fibers formed by extruding a molten thermoplastic material through a plurality of fine, usually circular, die capillaries as molten threads or fibers into converging high velocity gas (e.g. air) streams which attenuate the fibers of molten thermoplastic material to reduce their diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Buntin. Meltblown fibers may be continuous or discontinuous, are often smaller than 10 microns in average diameter and are frequently smaller than 7 or even 5 microns in average diameter, and are generally tacky when deposited onto a collecting surface.

As used herein, the term “elastic” when referring to a fiber, film, fabric or material means a material which upon application of a biasing force, is stretchable to a stretched, biased length which is at least about 150 percent, or one and a half times, its relaxed, unstretched length, and which will recover at least 50 percent of its elongation upon release of the stretching, biasing force. As an example, a one inch length sample of elastic material will be stretchable to at least one and one half inches, and upon release of the stretching force will recover to a length of not greater than one and one quarter inches.

As used herein, the term “hydrophilic” means that the polymeric material has a surface free energy such that the polymeric material is wettable by an aqueous medium, i.e. a liquid medium of which water is a major component. The term “hydrophobic” includes those materials that are not hydrophilic as defined. The phrase “naturally hydrophobic” refers to those materials that are hydrophobic in their chemical composition state without additives or treatments affecting the hydrophobicity. It will be recognized that hydrophobic materials may be treated internally or externally with surfactants and the like to render them hydrophilic.

### DESCRIPTION OF THE INVENTION

The present invention is directed to as-formed cross machine direction (CD) extensible nonwoven web materials and a method for making the CD extensible materials, and to laminates of such materials. The invention will be described with reference to the drawings which illustrate certain embodiments. It will be apparent to those skilled in the art that these embodiments do not represent the full scope of the invention which is broadly applicable in the form of variations and equivalents as may be embraced by the claims appended hereto. It is intended that the scope of the claims extend to all such variations and equivalents.

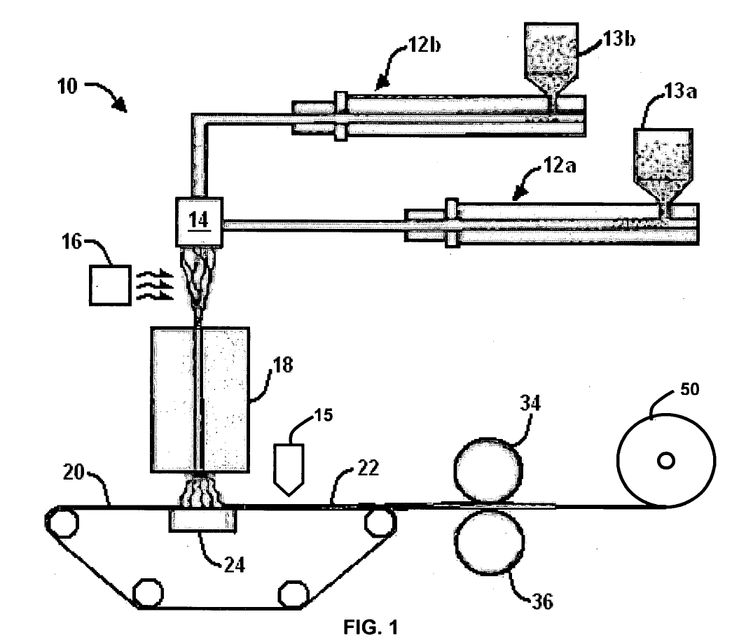

FIG. 1 schematically illustrates a process for forming the cross machine direction extensible nonwoven web material of the present invention. A process line 10 is arranged as a spunbond process to produce the CD extensible nonwoven web as a web of multicomponent fibers containing two polymer components. However, it should be understood that the present invention encompasses webs comprising monocomponent fibers, and also webs comprising multicomponent fibers which are made with more than two components. The process line 10 includes a pair of extruders 12a and 12b for separately extruding thermoplastic polymer component A and thermoplastic polymer component B. Thermoplastic polymer component A is fed into the respective extruder 12a from a first hopper 13a and thermoplastic polymer component B is fed into the respective extruder 12b from a second hopper 13b. Thermoplastic polymer components A and B are fed from the extruders 12a and 12b, respectively, to a spinneret 14. Spinnerets for extruding fibers and multicomponent fibers are well known to those of ordinary skill in the art and thus are not described here in detail. Generally described, the multicomponent spinneret 14 includes a housing containing a spin pack which includes a plurality of plates stacked one on top of the other with a pattern of openings arranged to create flow paths for directing polymer components A and B separately through the spinneret. An exemplary spin pack for producing multicomponent fibers is described in U.S. Pat. No. 5,989,004 to Cook, the entire contents of which are herein incorporated by reference.

Thermoplastic polymers suitable for use in producing the CD extensible nonwoven webs of the present invention include polyolefins, polyesters, polyamides, polycarbonates and copolymers and blends thereof. Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene; polybutylene, e.g., poly(1-butene) and poly(2-butene); polypentene, e.g., poly(1-pentene) and poly(2-pentene); poly(3-methyl-1-pentene); poly(4-methyl-1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine and the like, as well as blends and copolymers thereof. Suitable polyesters include polyethylene terephthalate, poly-butylene terephthalate, polytetramethylene terephthalate, polycyclohexylene-1,4-dimethylene terephthalate, and isophthalate copolymers thereof, as well as blends thereof.

Selection of a polymer (or polymers for components of multicomponent fibers where multicomponent fibers are used) is guided by end-use need, economics, and processability. It should be noted that the above listing of suitable polymers is not exhaustive and other polymers known to one of ordinary skill in the art may be employed. However, where multicomponent fibers are used, the particular combination of polymers selected to be the components of the multicomponent fiber should be capable of being co-spun in a fiber extrusion process, which will depend on such factors as, for example, the relative viscosities of the thermoplastic melts. In addition, it should be noted that the polymer or polymers may desirably contain other additives such as processing aids, treatment compositions to impart desired properties to the multicomponent fibers, residual amounts of solvents, pigments or colorants and the like.

Returning to FIG. 1, the spinneret 14 has openings or spinning holes called capillaries arranged in one or more rows. Each of the spinning holes receives predetermined amounts of the component extrudates A and B in a predetermined cross-sectional configuration, forming a downwardly extending strand of the multicomponent fibers. The cross-sectional configuration may be a crimpable configuration as is known in the art, such as for example a side-by-side configuration or an eccentric sheath-and-core configuration. The spinneret produces a curtain of the multicomponent fibers. A quench air blower 16 is located adjacent the curtain of fibers extending from the spinneret 14 to quench the fibers. The quench air can be directed from one side of the fiber curtain as shown in FIG. 1, or may be directed from quench air blowers positioned on both sides (not shown) of the fiber curtain. As used herein, the term “quench” simply means reducing the temperature of the fibers using a medium that is cooler than the fibers such as using, for example, ambient temperature air or chilled air.

The multicomponent fibers are then fed through a pneumatic fiber draw unit or aspirator 18 which provides the drawing force to attenuate the fibers, that is, reduce their diameter, and to impart molecular orientation therein and, thus, to increase the strength properties of the fibers. Pneumatic fiber draw units are known in the art, and an exemplary fiber draw unit suitable for the spunbond process is described in U.S. Pat. No. 3,802,817 to Matsuki et al., herein incorporated by reference. Generally described, the fiber draw unit 18 includes an elongate vertical passage through which the fibers are drawn by drawing aspirating air entering from the sides of and flowing downwardly through the passage. The aspirating air may be heated or unheated. Where crimped fibers are desired, the fibers can be simultaneously crimped and drawn during the fiber drawing process, when the components are arranged in a crimpable configuration by the use of heated aspirating air which both attenuates the filaments and activates latent helical crimp. This simultaneous drawing and crimping process is more fully disclosed in U.S. Pat. No. 5,382,400 to Pike et al., incorporated herein by reference. Alternatively, where crimped fibers are desired but when heating the aspirating air may be undesirable or impractical, the latent crimp in the fibers may be activated by the application of heat to the fibers of the web material at some point following fiber laydown.

An endless foraminous forming surface 20 is positioned below the fiber draw unit 18 to receive the drawn multicomponent fibers from the outlet opening of the fiber draw unit 18 as a formed web 22 of multicomponent fibers. A vacuum apparatus 24 is desirably positioned below the forming surface 20 to facilitate the proper placement of the fibers onto the foraminous forming surface 20. The formed web 22 will at this point in the process be a web loose unconsolidated fibers which may desirably be initially consolidated using consolidation means 15. Consolidation means 15 may be an air knife blowing heated air into and through the web of fibers, such as for example the hot air knife or “HAK” described in U.S. Pat. No. 5,707,468 to Arnold, et al., incorporated herein by reference. Consolidation means 15 acts to initially or preliminarily consolidate the nonwoven web to protect it from disruption until it can be bonded. The consolidation means shown at 15 may alternatively desirably be a compaction roller as is known in the art.

The fibers for the CD extensible nonwoven web should be laid down upon the foraminous forming surface 20 in such a manner that the nonwoven web as a whole has a greater overall fiber alignment or fiber directionality in the machine direction than in the cross machine direction. A useful measure of fiber alignment or overall fiber directionality is the ratio of the machine direction peak tensile strength to the cross machine direction peak tensile strength. This is often referred to simply as the “MD:CD tensile ratio” or “MD:CD ratio”. Desirably, the MD:CD tensile ratio will be at least 3:1, and more desirably at least 3.5:1 or as high as 4:1, 5:1, 10:1, or even higher. Having a high MD:CD ratio (and therefore high ratio of machine direction fiber alignment or directionality compared to the amount of cross machine direction fiber alignment or directionality) will assist in allowing the nonwoven web to have cross machine direction extensibility. Where a linear draw unit of the type disclosed in U.S. Pat. No. 3,802,817 to Matsuki et al. is used, the forming height may be altered from those taught in Matsuki et al. to assist in producing webs having higher MD:CD tensile ratios. As an example, instead of using the 40 to 70 centimeters (about 16 inches to 28 inches) forming height range described in Matsuki et al., shorter forming heights of about 30 cm (12 inches) have been found to be useful. More particularly, forming heights ranging from about 23 cm (about 9 inches) to about 15 cm (about 6 inches) may be useful to help align the fibers of the web more in the machine direction and achieve higher MD:CD tensile ratios. In addition, where a vacuum apparatus is employed below the foraminous forming surface, such as vacuum apparatus 24 described with reference to FIG. 1 above, we believe reducing the amount of vacuum (that is, the amount of air drawn through the foraminous forming surface by the vacuum apparatus) may also be beneficial in increasing the MD orientation of the fibers and thus the MD:CD tensile ratio of the bonded nonwoven web materials.

As shown in FIG. 1, the formed web 22 is then carried on the foraminous surface 20 to a calender bonding station which employs pattern bonding roll pairs 34 and 36 for effecting bond points at limited areas of the web by passing the web through the nip formed by the bonding rolls 34 and 36. One or both of the roll pair have a pattern of land areas and depressions on the surface, which effects the bond points, and either or both may be heated to an appropriate temperature. The temperature of the bonding rolls and the nip pressure are selected so as to effect bonded regions without having undesirable accompanying side effects such as excessive shrinkage, excessive fabric stiffness and web degradation.

Various patterns for calender rolls have been developed for functional as well as aesthetic reasons. One example of a pattern has points and is the Hansen and Pennings or “H&P” pattern with about a 30% bond area with about 200 bonds/square inch as taught in U.S. Pat. No. 3,855,046 to Hansen and Pennings. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). Another typical point bonding pattern is the expanded Hansen and Pennings or “EHP” bond pattern which produces a 15% bond area with a square pin having a side dimension of 0.037 inches (0.94 mm), a pin spacing of 0.097 inches (2.464 mm) and a depth of 0.039 inches (0.991 mm). Another typical point bonding pattern designated “714” has square pin bonding areas wherein each pin has a side dimension of 0.023 inches, a spacing of 0.062 inches (1.575 mm) between pins, and a depth of bonding of 0.033 inches (0.838 mm). The resulting pattern has a bonded area of about 15%. Yet another common pattern is the wire weave pattern looking as the name suggests, e.g. like a window screen, which has about 302 pins/in2 with a bond area of about 15% to about 20%. Typically, the percent bonding area varies from around 10% to around 30% of the area of the fabric laminate web. Thermal point bonding imparts integrity to individual layers by bonding fibers within the layer and/or for laminate materials, point bonding holds the layers together to form a cohesive laminate material.

Particularly useful thermal point bonding patterns are those having bond elements which facilitate CD extensibility of the material. As examples, the bond elements may be arranged such that the pin elements have a greater dimension in the machine direction than in the cross-machine direction. Linear or rectangular-shaped pin elements with the major axis aligned substantially in the machine direction are examples of this.

Alternatively, or in addition, useful bonding patterns may have pin elements arranged so as to leave machine direction running “lanes” or lines of unbonded or substantially unbonded regions running in the machine direction, so that the CD extensible nonwoven web material has additional give or extensibility in the cross machine direction. Such bonding patterns as are described in U.S. Pat. No. 5,620,779 to Levy et al., incorporated herein by reference, may be useful, and in particular the “rib-knit” bonding pattern therein described.

The cross machine direction extensibility of the CD extensible nonwoven webs may be enhanced by other optional elements. As an example, crimped fibers as are discussed above may be utilized so that those fibers in the web which do have a primary orientation in the cross machine direction (or those portions of the fibers which have primary orientation in the cross machine direction) will be allowed to “give” or extend somewhat more in the cross machine direction via a straightening out of the crimps in the fibers. Fiber crimping may be produced with the bicomponent fiber system discussed above by utilizing the methods such as are described in U.S. Pat. No. 5,382,400 to Pike et al. As an alternative to bicomponent fibers, fiber crimp may be produced in homofilament fibers (fibers having one polymer component) by utilizing the teachings disclosed in U.S. Pat. No. 6,446,691 to Maldonado et al. and U.S. Pat. No. 6,619,947 to Pike et al., both incorporated herein by reference.

Lastly, the process schematically depicted in FIG. 1 further includes a winding roll 50 for taking up the bonded web of CD extensible nonwoven web 40. As an alternative to winding up on roll 50, the CD extensible nonwoven web 40 may be directed for further processing, or into a converting process for the making of a product. The CD extensible nonwoven web materials of the present invention desirably have a basis weight of from about 1 to about 68 grams per square meter (gsm), although heavier weight fabrics may be used. In low cost applications, such as for disposable products such as personal care absorbent products, the CD extensible nonwoven webs may desirably have a basis weight less than about 34 gsm, and more particularly in low cost applications it may be desirable for the CD extensible nonwoven webs to have a basis weight less than about 17 gsm.

While not shown here, various additional potential processing and/or finishing steps known in the art such as aperturing, slitting, stretching, treating, or lamination of the CD extensible nonwoven material with other films or other nonwoven layers, may be performed without departing from the spirit and scope of the invention. Examples of web treatments include electret treatment to induce a permanent electrostatic charge in the web, or in the alternative antistatic treatments. Another example of web treatment includes treatment to impart wettability or hydrophilicity to a web comprising hydrophobic thermoplastic material. Wettability treatment additives may be incorporated into the polymer melt as an internal treatment, or may be added topically at some point following filament or web formation.

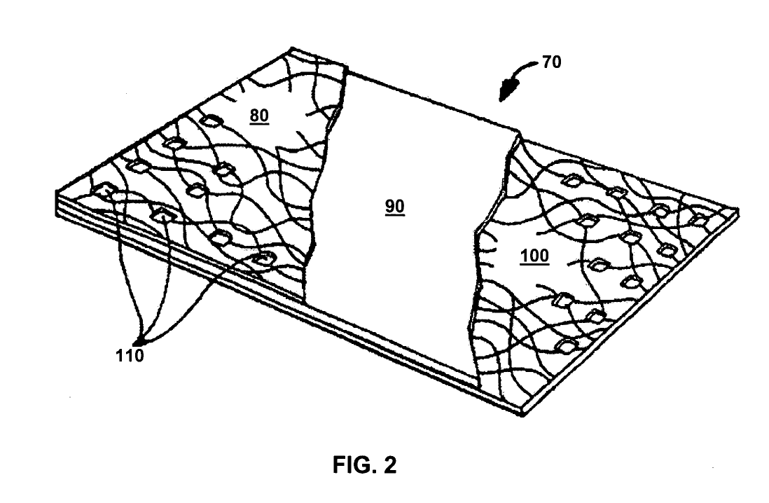

Examples of lamination of the CD extensible nonwoven material with films or other nonwoven layers include laminate having two or more layers, such as the exemplary tri-layer laminate material shown in FIG. 2. FIG. 2 is a schematic only, simply illustrative of one of the types of laminates intended. Generally, such multi-layer nonwoven laminate materials have a basis weight of from about 3 to about 400 gsm, or more particularly from about 15 gsm to about 150 gsm. As shown in FIG. 2, the tri-layer embodiment of the laminate material is generally designated 70 and comprises an inner layer 90, which is sandwiched between two outer or “facing” layers designated 80 and 100. Additionally shown in FIG. 2 are bond points 110 such as may be made by a thermal point bonding process. Any or all of the layers 80, 90 or 100 may be a CD extensible nonwoven web of the invention. However, the CD extensible nonwoven webs may be particularly useful as an extensible facing layer or layers laminated to an extensible or elastic inner layer. Inner layer 90 may desirably be a barrier layer such as a nonwoven microfiber layer (such as a meltblown layer) or one or more film layers such as are known in the art. Exemplary laminate materials comprising meltspun microfiber layer such as a meltblown layer to make a spunbond-meltblown-spunbond or “SMS” laminate material are disclosed in U.S. Pat. No. 4,041,203 to Brock et al., which is incorporated herein in its entirety by reference.

As stated above, the nonwoven laminate material may desirably comprise a film layer acting as a barrier layer. As an example, a “breathable” film layer which is permeable to vapors or gas yet substantially impermeable to liquid, such as is known in the art can be laminated between the outer nonwoven web layers of continuous fibers to provide a breathable barrier laminate that exhibits a desirable combination of useful properties such as soft texture, strength and barrier properties. Generally speaking, film is considered “breathable” if it has a water vapor transmission rate of at least 300 grams per square meter per 24 hours (g/m2/24 hours), as calculated in accordance with ASTM Standard E96-80. Exemplary breathable film-nonwoven laminate materials are described in, for example, U.S. Pat. No. 6,037,281 to Mathis et al, herein incorporated by reference in its entirety.

Films useful for making laminates with the CD extensible nonwoven webs of the invention include elastic films made from elastic polyolefin resins and films made from traditional elastic block copolymers. Examples of elastic block copolymers include those having the general formula A-B-A′ or A-B, where A and A′ are each a thermoplastic polymer endblock which contains a styrenic moiety such as a poly (vinyl arene) and where B is an elastomeric polymer midblock such as a conjugated diene or a lower alkene polymer such as for example polystyrene-poly(ethylene-butylene)-polystyrene block copolymers. Also included are polymers composed of an A-B-A-B tetrablock copolymer, as discussed in U.S. Pat. No. 5,332,613 to Taylor et al. In such polymers, A is a thermoplastic polymer block and B is an isoprene monomer unit hydrogenated to substantially a poly(ethylene-propylene) mono-mer unit. An example of such a tetrablock copolymer is a styrene-poly(ethylene-propylene)-styrene-poly(ethylene-propylene) or SEPSEP block copolymer. These A-B-A′ and A-B-A-B copolymers are available in several different formulations from the Kraton Polymers of Houston, Tex. under the trade designation KRATON®).

Examples of elastic polyolefins include ultra-low density elastic polypropylenes and polyethylenes, such as those produced by “single-site” or “metallocene” catalysis methods. Such polymers are commercially available from the Dow Chemical Company of Midland, Mich. under the trade name ENGAGE®, and described in U.S. Pat. Nos. 5,278,272 and 5,272,236 to Lai et al entitled “Elastic Substantially Linear Olefin Polymers”. Also useful are certain elastomeric polypropylenes such as are described, for example, in U.S. Pat. No. 5,539,056 to Yang et al. and U.S. Pat. No. 5,596,052 to Resconi et al., incorporated herein by reference in their entireties, and polyethylenes such as AFFINITY® EG 8200 from Dow Chemical of Midland, Mich. as well as EXACT® 4049, 4011 and 4041 from Exxon of Houston, Tex., as well as blends.

Other films useful for making laminates with the CD extensible nonwoven webs of the invention include multi-layer films. Multi-layer films can be formed by a wide variety of processes well known to those of ordinary skill in the film forming industry. Two particularly advantageous processes are cast film coextrusion processes and blown film coextrusion processes. In such processes, the multiple layers of the film are formed simultaneously and exit the extruder in a multi-layer form. Such multi-layer films and process are described in, for example, U.S. Pat. No. 4,522,203 to Mays and U.S. Pat. No. 4,734,324 to Hill. A multi-layer film useful in laminates with the CD extensible nonwoven web material may have a core or central layer of a thermoplastic elastic material, and thin external or “skin” layers which comprise a bonding agent, so as to facilitate bonding of the elastic film to the nonwoven fibrous webs. Such multi-layer films are described in, for example, U.S. Pat. No. 6,114,024 to Forte and in U.S. Pat. No. 6,309,736 to McCormack et al. Examples of bonding agents are described in, for example, U.S. Pat. No. 6,238,767 to McCormack and Haffner and U.S. Pat. No. 5,695,868 to McCormack and include but are not limited to amorphous polymers, such as a propene-rich polyalphaolefin terpolymer or copolymer, polyamides, ethylene copolymers such as ethylene vinyl acetate (EVA) and ethylene methyl acrylate (EMA) and the like, wood rosin and its derivatives, hydrocarbon resins, polyterpene resins, atactic polypropylene and amorphous polypropylene.

### EXAMPLES

Test Method, Strip Tensile: The strip tensile test measures the peak and breaking loads and peak and break percent elongations of a fabric. This test measures the load (strength) in grams and elongation in percent. In the strip tensile test, two clamps, each having two jaws with each jaw having a facing in contact with the sample, hold the material in the same plane, usually vertically, separated by 3 inches and move apart at a specified rate of extension. Values for strip tensile strength and strip elongation are obtained using a sample size of 3 inches by 6 inches, with a jaw facing size of 1 inch high by 3 inches wide, and a constant rate of extension of 300 mm/minute. The Sintech 2 tester, available from the Sintech Corporation, 1001 Sheldon Dr., Cary, N.C. 27513, was used to test and record the results of strip tensile testing for the Examples and Comparative materials. The Instron Model™, available from the Instron Corporation, 2500 Washington St., Canton, Mass. 02021, or a Thwing-Albert Model INTELLECT II available from the Thwing-Albert Instrument Co., 10960 Dutton Rd., Philadelphia, Pa. 19154 may also be used for this test. Unless otherwise stated, results were reported as an average for five specimens tested for each of materials tested and were performed for both the cross machine direction (CD) and the machine direction (MD).

Five Example materials were produced using a spunbond nonwoven production process essentially as described above. All Example materials were approximately 0.5 osy (about 17 gsm) in basis weight and fiber sizes were 18-20 microns in diameter. Examples 1-3 were polypropylene/polyethylene side-by-side bicomponent fiber spunbond webs produced by a process substantially as described above with respect to FIG. 1; the fiber drawing unit supplied unheated air in order to produce substantially uncrimped fibers. Examples 4-5 were also polypropylene/polyethylene side-by-side bicomponent fiber spunbond webs which were produced substantially as described above with respect to FIG. 1. For Examples 4-5, the fiber drawing unit was heated to about 235 degrees F. (about 113 degrees C.) with heated air in order to activate the latent crimp in the side-by-side bicomponent fibers and thereby produce crimped fiber nonwoven webs. After collecting the spunbond fibers onto the forming surface, all Examples were bonded using a rib knit thermal spot bonding pattern as described above. For all of the Examples, the amount of air drawn through the foraminous forming surface by the vacuum apparatus positioned below the forming surface was reduced from the typical flow setting, such that the face velocity of air drawn through the forming surface was reduced to approximately 25 percent, from about 8 meters per second to about 2 meters per second.

Commercially produced spunbond nonwoven web materials were obtained as Comparative materials. Comparative 1 material was a 0.45 osy (15.3 gsm) spunbond polypropylene web material produced by the Kimberly-Clark Corporation of Irwin, Tex. for use as a diaper liner material. Comparative 2 material was a 0.45 osy (15.3 gsm) spunbond polypropylene web material available from BBA Nonwovens of Trezzano Rosa, Italy. All Example and Comparative materials had a substantially uniform basis weight, and substantially uniform large-scale visual appearance. That is to say, while the Example and Comparative materials may have had the type of small-scale and random non-uniformities as are common with spunbonded nonwoven webs, none exhibited any repeating pattern of alternating heavy and light areas or high density and low density strips as was discussed above with respect to previously known CD extensible materials. All Example and Comparative materials were tested for strip tensile measurements in both the CD and MD in accordance with the above description. Each Example material was tested with N=5 repetitions and the two Comparative materials were tested with N=10 repetitions.

The results of strip tensile testing are listed in TABLE 1 showing the load in grams required to extend each sample in the MD and CD to 10% and 30% elongation, and the peak load in grams and peak strain in terms of percent elongation. The percent elongation refers to the distance a material is extended greater than its starting length. For example, a 10 centimeter sample of material extended to 13 centimeters corresponds to a 30 percent elongation. Peak Load is recorded for the highest force encountered when extending the material sample during the test, and Peak Strain is the percent elongation at which the Peak Load occurs. Generally, the Peak Load is reached at the point just at or just before the material undergoes failure or breakage or tearing.

TABLE 1

| | | | | | | | Peak | |
|---|---|---|---|---|---|---|---|---|
| | Load, 10% | | Load, 30% | | Peak Load | | Strain | |
| Material | CD | MD | CD | MD | CD | MD | CD | MD |
| Ex. 1 | 32 | 1500 | 218 | 3221 | 629 | 3943 | 138 | 63 |
| Ex. 2 | 24 | 2088 | 200 | 3528 | 746 | 4063 | 159 | 54 |
| Ex. 3 | 18 | 1858 | 116 | 3468 | 464 | 4104 | 172 | 62 |
| Ex. 4 | 55 | 1236 | 255 | 2274 | 730 | 2691 | 126 | 59 |
| Ex. 5 | 37 | 1110 | 201 | 2409 | 713 | 3046 | 164 | 65 |
| Comp. 1 | 1085 | 3679 | 2007 | 5496 | 2586 | 6169 | 53 | 45 |
| Comp. 2 | 944 | 2625 | 2243 | 4552 | 3447 | 5715 | 66 | 56 |

As can be seen from TABLE 1, all of the materials, Example and Comparative, require considerably less force to elongate the material in the cross machine direction or CD compared to the force required to elongate the material in the machine direction or MD. However, this effect is much more pronounced in the Example materials. In addition, the cross machine direction peak strain (percent elongation at material breakage) is much higher for the Example materials than for the commercially available Comparative materials, demonstrating that the Example materials have a much higher overall CD extensibility. Furthermore, despite requiring much less force to extend the material in the cross machine direction, these Example materials still demonstrate acceptable total tensile strength in the CD. As an example, when comparing the force required to extend the sample materials in the CD to the 10% and 30% elongation points, it can be seen that for all Example materials the force to extend each Example material to 10% elongation is less than 10 percent of the total CD tensile strength for that material. Similarly, the force required to extend the Example materials to the 30% elongation point is 35 percent or less of the total CD tensile for all the Examples. However, for the Comparative materials 1 and 2, the force required to extend the materials to the 10% elongation point is 27 and 42 percent, respectively, of the total CD tensile and 65 and 78 percent, respectively, of the total CD tensile for the 30% elongation point. The data in TABLE 1 were also combined to show ratios of CD loads and elongation vs. MD loads and elongation for each of the Example and Comparative materials. These results are shown in TABLE 2.

TABLE 2

| | | | | |
|---|---|---|---|---|
| | Load, 10% | Load, 30% | Peak Load | Peak Strain |
| Material | CD:MD | CD:MD | CD:MD | CD:MD |

| | | | | |
|---|---|---|---|---|
| Ex. 1 | 2% | 7% | 16% | 219% |
| Ex. 2 | 1% | 6% | 18% | 294% |
| Ex. 3 | 1% | 3% | 11% | 277% |
| Ex. 4 | 4% | 11% | 27% | 214% |
| Ex. 5 | 3% | 8% | 23% | 252% |
| Comp. 1 | 29% | 37% | 42% | 118% |
| Comp. 2 | 36% | 49% | 60% | 118% |

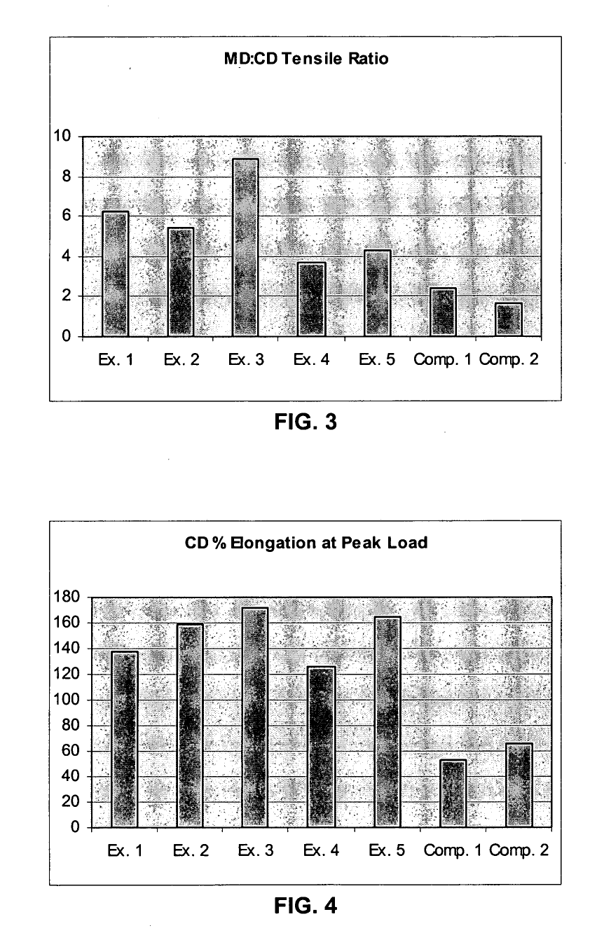

The bar graphs shown in FIG. 3 through FIG. 7 were produced using the results in TABLE 1 and TABLE 2 to help illustrate the extensibility of the materials compared to the commercially available spunbonded materials. As can be seen in FIG. 3, the graph showing a comparison between the MD:CD tensile ratios of all the materials (this is the inverse of the CD:MD Peak Load ratio expressed as a percent in TABLE 2), the Examples all have an MD:CD tensile ratios greater than 3:1, and range from 3.7:1 to 9:1, while for the two Comparative materials MD:CD tensile ratios are much lower, ranging from 1.7:1 to 2.4:1. This is a measure of to what extent the fibers in the nonwoven web are MD oriented and an indication of CD extensibility. FIG. 4 graphically represents the overall cross machine direction extensibility of the Example materials compared to the commercially available comparative spunbonded materials. FIG. 4 was produced using the CD Peak Strain values in TABLE 1, and as can be seen in FIG. 4 the Example material having the lowest CD elongation at peak load (Ex. 4 at 126%) still has nearly two times the CD elongation at peak load of the Comparative material having the higher CD elongation at peak load (Comp. 2 at 66%).

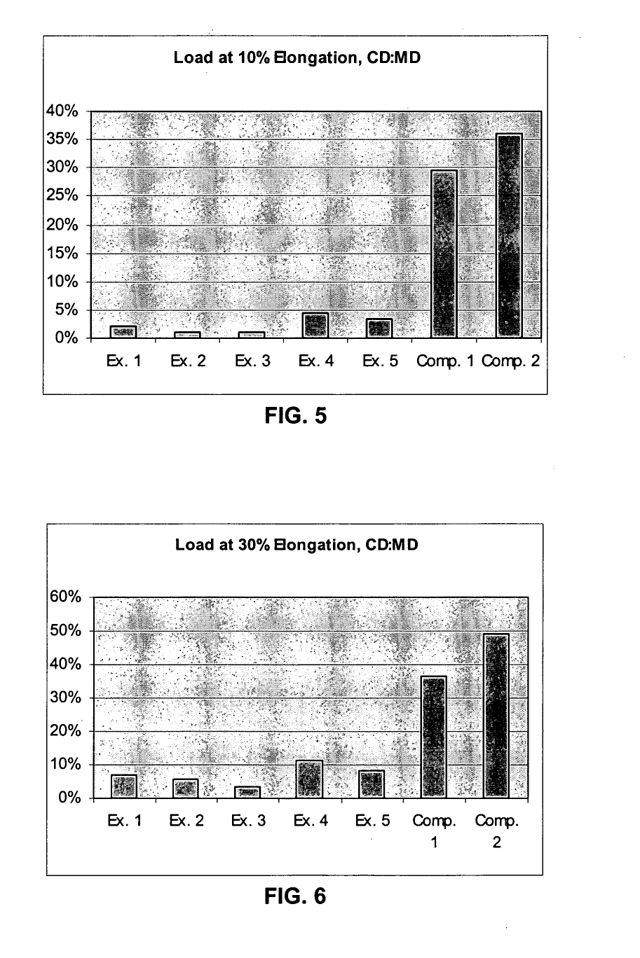

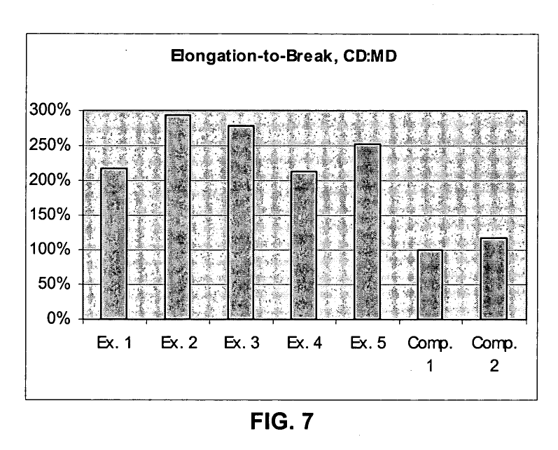

When the ease of extending each the Example materials in the cross machine direction is compared to each material's own machine direction extensibility, it can be seen in TABLE 2 that for a 10% extension, the force required for CD extension is less than 5% of the force required for MD extension for each of the Example materials. However, for the Comparative 1 and 2 materials the force required for CD extension to 10% is nearly 29% and 36%, respectively, of the force required for MD extension of those materials. This result is graphically demonstrated in FIG. 5. Similarly, and as is shown in FIG. 6 and TABLE 2, the ratio of force required to CD extend to 30 percent versus force required to MD extend to 30 percent is very low for the Example materials (all at 11% or less) compared to the two commercially available materials tested (37% and 49%). Finally, FIG. 7 demonstrates for each material the ratio of CD:MD elongation to break (produced from the CD:MD Peak Strain ratio expressed as a percent in TABLE 2). As can be clearly seen in FIG. 7, the Example materials are each capable of extending 2 to 3 times farther in the CD than in the MD before breaking, while the two Comparative materials each have a CD-to-MD elongation at break of about 1:1.

While various patents have been referred to and incorporated herein by reference, to the extent there is any inconsistency between incorporated material and that of the written specification, the written specification shall control. In addition, while the invention has been described in detail with respect to specific embodiments thereof, it will be apparent to those skilled in the art that various alterations, modifications and other changes may be made to the invention without departing from the spirit and scope of the present invention. It is therefore intended that the claims cover all such modifications, alterations and other changes encompassed by the appended claims.

1. A method of making an as-formed cross direction extensible nonwoven web comprising:
a) extruding continuous thermoplastic fibers having an average diameter greater than about 10 microns;
b) quenching the fibers;
c) melt-attenuating the fibers;
d) collecting the continuous thermoplastic fibers on a moving foraminous forming surface to form an unbonded nonwoven web; and
e) pattern bonding the nonwoven web by the application of heat and pressure;
wherein the bonded nonwoven web has substantially uniform basis weight, and further wherein the tensile force required to extend the bonded nonwoven web 30 percent in the cross machine direction is less than about 60 percent of the cross machine direction peak tensile force of the bonded nonwoven web.

2. The method of claim 1 wherein the tensile force required to extend the bonded nonwoven web 30 percent in the cross machine direction is less than about 50 percent of the cross machine direction peak tensile force of the bonded nonwoven web.

3. The method of claim 2 wherein the tensile force required to extend the bonded nonwoven web 30 percent in the cross machine direction is less than about 40 percent of the cross machine direction peak tensile force of the bonded nonwoven web.

4. The method of claim 1 wherein the bonded nonwoven web has a MD:CD tensile strength ratio of at least about 3:1.

5. The method of claim 1 wherein the continuous thermoplastic fibers are extruded in a crimpable cross sectional configuration and further including the step of applying heat to the fibers to activate crimp.

6. The method of claim 5 wherein the step of applying heat to the fibers is performed prior to the step of collecting the fibers on the foraminous forming surface.

7. The method of claim 5 wherein the step of applying heat to the fibers is performed after the step of collecting the fibers on the foraminous forming surface.

8. The method of claim 5 wherein the crimpable cross sectional configuration is side-by-side or eccentric sheath-core configuration.

9. The method of claim 1 further including the step of laminating the nonwoven web to at least one additional layer.

10. The method of claim 9 wherein the at least one additional layer is selected from the group consisting of breathable films, elastic films, foams, and nonwoven webs.

11. A cross machine direction extensible nonwoven web comprising continuous thermoplastic fibers and a plurality of thermal bond points in a pattern, the continuous thermoplastic fibers having an average diameter greater than about 10 microns, the nonwoven web having substantially uniform basis weight, and wherein the force required to extend the bonded nonwoven web 30 percent in the cross machine direction is less than about 60 percent of the cross machine direction peak tensile force of the bonded nonwoven web.

12. The nonwoven web of claim 11 wherein the force required to extend the bonded nonwoven web 30 percent in the cross machine direction is less than about 50 percent of the cross machine direction peak tensile force of the bonded nonwoven web.

13. The nonwoven web of claim 11 wherein the force required to extend the bonded nonwoven web 30 percent in the cross machine direction is less than about 40 percent of the cross machine direction peak tensile force of the bonded nonwoven web.

14. The nonwoven web of claim 13 wherein the continuous thermoplastic fibers are crimped multicomponent fibers.

15. A laminate material comprising the nonwoven web of claim 11 and at least one additional layer.

16. The laminate material of claim 15 wherein the at least one additional layer is selected from the group consisting of breathable films, elastic films, foams, and nonwoven webs.

17. A cross machine direction extensible nonwoven web comprising continuous thermoplastic fibers and a plurality of thermal bond points in a pattern, the continuous thermoplastic fibers having an average diameter greater than about 10 microns, the nonwoven web having substantially uniform basis weight, and wherein the force required to extend the bonded nonwoven web 30 percent in the cross machine direction is less than about 30 percent of the force required to extend the web to 30 percent in the machine direction.

18. The nonwoven web of claim 17 wherein the force required to extend the bonded nonwoven web 30 percent in the cross machine direction is less than about 25 percent of the force required to extend the web to 30 percent in the machine direction.

19. The nonwoven web of claim 18 wherein the force required to extend the bonded nonwoven web 30 percent in the cross machine direction is less than about 20 percent of the force required to extend the web to 30 percent in the machine direction.

20. The nonwoven web of claim 17 wherein the continuous thermoplastic fibers are crimped multicomponent fibers.

21. A laminate material comprising the nonwoven web of claim 17 and at least one additional layer.

22. The laminate material of claim 21 wherein the at least one additional layer is selected from the group consisting of breathable films, elastic films, foams, and nonwoven webs.
